(19) United States
(12) Patent Application Publication
(10) Pub. No.: US 2021/0372454 A1
(43) Pub. Date: Dec. 2, 2021

(54) FASTENING ELEMENT

(71) Applicant: Bossard AG, Zug (CH)

(72) Inventor: Werner Pfister, Stretten (CH)

(21) Appl. No.: 16/341,775

(22) PCT Filed: Oct. 13, 2017
(86) PCT No.: PCT/EP2017/076238

§ 371 Date: Apr. 12, 2019

(30) Foreign Application Priority Data
Oct. 17, 2016 (EP) 16194159.6

(51) Int. Cl. F16B 25/00

(52) U.S. Cl. CPC F16B 25/0015; F16B 25/0047

(57) ABSTRACT

Fastening element (100) for a porous material, in particular for balsa wood, comprising a fastening head (1) configured to receive a torque in both rotational directions around a main axis (10) and a shank (2) that extends from the fastening head (1) and ends in a tip (3) at the end facing away from the fastening head. The shank (2) has an outer thread (4) along at least a section of its extension in a direction of the main axis (10), for screwing the fastening element (100) into the material.

### TECHNICAL FIELD

The present invention refers to a fastening element for a porous material and a use of the fastening element.

### BACKGROUND ART

If using a fastening element in a porous material or in a soft wood, it needs to be considered that such materials have cavities inside and therefore have only few supporting material close by the fastening element such that the load capacity of the material is limited.

If fastening elements that are known from the state of the art, in particular screws, are used for a porous material, this has often the effect that the screw pulls out of the material due to the limited load capacity and therefore reduced force absorption of the material.

### DISCLOSURE OF THE INVENTION

In view of the known state of the art, the problem to be solved by the present invention is therefore to provide a fastening element that is suitable for the use in porous materials as well as in soft woods and that ensures a secure junction for these materials.

This problem is solved by the fastening element according to claim 1.

Accordingly, the inventive fastening element comprises a fastening head configured to receive a torque in both rotational directions, therefore in a clockwise and a counterclockwise direction, around a main axis. In addition, the fastening element comprises a shank extending from the fastening head and ending in a tip at the end facing away from the fastening head. The shank comprises an outer thread along at least a section of its extension in a direction of the main axis, for screwing the fastening element into a porous material, in particular into a balsa wood.

A ratio of an outer diameter D of the outer thread, in particular the largest outer diameter D of the outer thread, to the core diameter d of the outer thread is D/d>2.5, but can also be, in particular for balsa wood, D/d>2.8, for at least a section of the extension of the outer thread in a direction of the main axis. Preferably, the ratio is 3>D/d>2.5.

The outer diameter refers to the outer diameter of a cross section of the outer thread, measured from the thread tip. The core diameter refers to the diameter of the cross section of the thread measured on the thread base.

Preferably, the outer diameter of the outer thread is between 4 mm and 5 mm and/or the core diameter of the outer thread between 1 mm and 2 mm.

Preferably, the core diameter d of the outer thread remains the same along the total length of the outer thread.

The outer thread has a first thread flank facing the fastening head and a second thread flank facing away from the fastening head.

The thread profile of the second thread flank has a kink. Therefore, the second thread flank has a first section between the kink and the thread base and a second section between the kink and the thread tip.

A first angle between the first thread flank and the first section of the second thread flank is larger than a second angle between the first thread flank and the second thread section of the second thread flank.

Preferably, the kink is formed exclusively along the second thread flank, such that the kink is continuously formed on only one side of the thread.

Preferably, the first thread flank is formed without kink. This means that an angle between the first thread flank and the thread base is constant along the whole thread profile of the first thread flank from the thread tip to the thread base.

The thread is preferably configured to be defined by means of three angles. The three angles are the angle between the thread base and the first thread flank, the angle between the thread base and the first section of the second thread flank, and the angle between the thread base and the second section of the second thread flank.

In a further preferred embodiment of the fastening element, the first thread flank and the second thread flank are configured such that the first angle is between 45° and 65° and preferably between 55° and 60°. The second angle might be between 20° and 40° and preferably between 30° and 35°.

Preferably, the outer thread of the inventive fastening element is formed as a self-tapping thread, such that the fastening element forms itself a thread if screwed into the material.

The thread is preferably configured as a single-start thread having one ridge, but it can also be configured as a multiple-start thread having multiple ridges.

In a preferred embodiment of the fastening element, the section of the shank that encloses the outer thread extends until the tip of the fastening element. This means that the outer thread is formed until the tip of the element and builds the thread runout of the outer thread close by the tip. Preferably, the outer diameter of the outer thread decreases in a region of the shank close by the tip. In particular, the outer diameter of the thread runout of the outer diameter is close to the tip more than 20%, in particular more than 50% smaller than the maximum outer diameter of the thread.

The thread pitch s of the outer thread D is preferably between 1.5 mm and 2 mm.

The ratio between the outer diameter D and the thread pitch s is in one embodiment 2<D/s<3, in particular D/s=2.5.

For a preferred fastening element, the length between an end of the shank facing the fastening head to the tip of the fastening element is between 10 mm and 25 mm.

In addition, the fastening element comprises preferably steel, aluminium, or fiber-reinforced plastic. In particular, it is made in one piece out of one of these materials. In a further embodiment, the element can comprise a combination of said materials, for example, the fastening head can be made out of another material than the shank or than the section of the shank that comprises the thread.

In a further embodiment of the fastening element, the outer thread can extend along the whole shank from the tip until the fastening head. Preferably, the outer thread extends only along a portion, respectively a section of the shank, such that a section between the fastening head and the section of the shank that is formed as an outer thread, is thread-free.

In particular, a diameter of the thread-free section can be approximately the same as the largest outer diameter of the outer thread.

In addition, a diameter of the thread-free section can be smaller than a diameter of the fastening head, in particular 20%, 30%, or 40% smaller.

The fastening head of the element is configured to receive a torque for rotating the element in both rotational direction around the main axis. In particular, the fastening head has therefore a reception that can be connected with a suitable tool, for transmitting a torque. The reception can be formed as hexagonal, as a slot, or preferably as a hexalobular socket.

The fastening head might be formed as a pan head or countersunk head.

Preferably, the fastening head is furthermore configured such that a diameter of the head is larger than an outer diameter of the outer thread, in particular larger than the largest outer diameter of the outer thread. Preferably, a diameter of the fastening head is more than 20% larger than the largest outer diameter of the outer thread.

Preferably, the fastening element is a screw and in particular is a wood screw.

According to the invention, a use of the inventive fastening element is to screw it into the porous material.

Preferably, the material is balsa wood, foamed plastic or foamed aluminium.

A further preferred material is a material with a density p of less than 1 g/cm³ (ρ<1 g/cm³).

When screwing in the inventive fastening element, the porous material in the surrounding area of the outer thread is compressed, such that the material in the surrounding of the outer thread becomes more load bearing and the fastening element is fixed to the material in a positive locking manner.

Compared to the state of the art, to achieve a secure junction, a decisive factor is in particular the inventive interaction of the diameter ratio between the core diameter d and the outer diameter D of the outer thread with the thread profile of the outer thread.

While being screwed into the material, the outer thread forms a thread into the material, preferably by means of forming, compressing, or engraving of the material.

Due to the ratio of the diameters of D/d>2.5, the outer thread forms a large depth of the thread, such that a large volume of material is compressed when screwing the fastening element into a porous material, leading to a high load absorption of the material, such that the fastening element can withstand higher loads than if a smaller volume of material would be compressed.

To facilitate the screwing of the inventive fastening element with a diameter ratio of D/d>2.5 into a material, the outer thread has an inventive thread profile having a first thread flank and a second thread flank with a kink that divides the second flank into the first and the second section. The inventive form of the thread flanks, in particular of the two sections of the second thread flank, leads to the compression of the material in the surrounding of the outer thread, in particular in the surrounding of the thread base of the outer thread, while screwing in the fastening element, for facilitating the screwing in of the fastening element.

The inventive fastening element is an essential element for any device that comprises in particular porous materials. It serves preferably for securely connecting individual components of a device and therefore enables the functionality of the device.

### BRIEF DESCRIPTION OF THE DRAWINGS

Further embodiments, advantageous and applications of the invention result from the dependent claims and the following description with reference to the drawings. Wherein:

FIG. 1 is a front view of the fastening element according to an embodiment of the invention;

FIG. 2 is a side view of the fastening element from FIG. 1 according to an embodiment of the invention; and

FIG. 3 is a section view of a detail view of detail A of FIG. 1 according to an embodiment of the invention.

### MODES FOR CARRYING OUT THE INVENTION

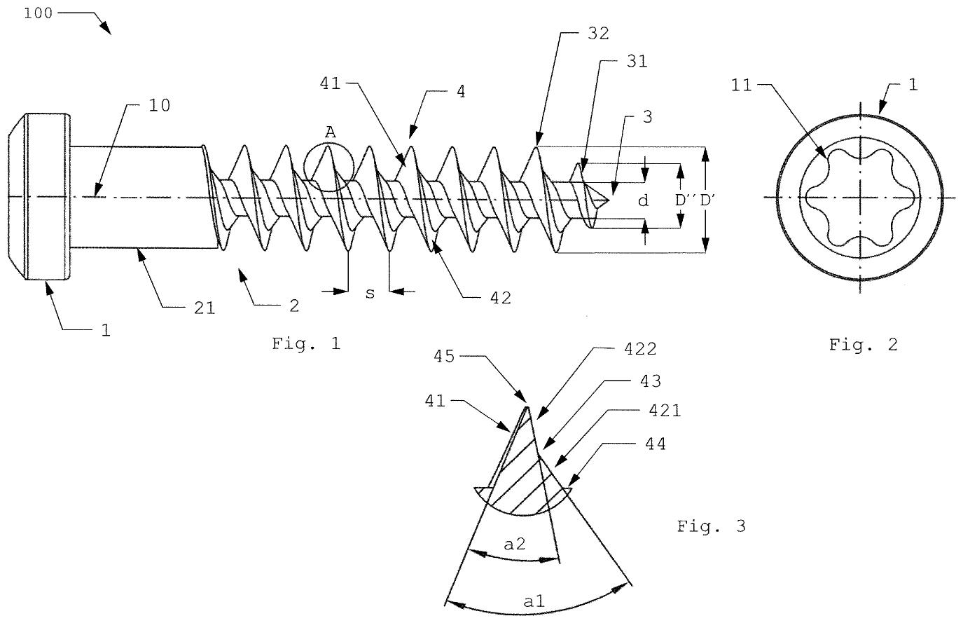

FIG. 1 shows an embodiment of the inventive fastening element 100 comprising a fastening head 1 and a shank 2 that extends from the fastening head 1 towards a main axis 10 and ends in a tip 3 at an end facing away from the fastening head 1.

A length of the shank 2 from one end of the shank 2 that extends from the fastening head 2 until the tip 3 is preferably about 22 mm or about 25 mm.

The shank 2 has an outer thread 4 along a section of its extension in a direction of the main axis 10. The outer thread 4 shown in the figure is a right-handed thread, this means that a front view on the thread shows the ridges ascending towards the right side and therefore the thread is screwed into the material in clockwise direction. In another embodiment, the outer thread 4 might also be a left-handed thread, being screwed into a material in a counterclockwise direction.

A ratio of the diameter D of the outer thread, in particular the largest diameter D′ of the outer thread 4, also known as nominal diameter, and the core diameter d of the thread 4 is D/d>2.5 or D/d>2.8 or 3>D/d>2.5 over at least a portion of the extension of the thread 4 along the shank 2 in a direction of the main axis 10.

The largest outer diameter D′ of the thread is preferably around 4.2 mm. The core diameter d of the thread is preferably around 1.5 mm.

A ratio of the largest outer diameter D′ and the thread pitch s is preferably 2.5.

The outer thread 4 has a first thread flank 41 facing towards the fastening head 1 and a second thread flank 42 facing away from the fastening head 1 in a direction towards the tip 3.

The section of the shank 2 that is formed as an outer thread 4 extends until the tip 3. The outer diameter D of the outer thread 4 decreases towards the tip and is smaller than the largest outer diameter D′ of the outer thread. The outer diameter D″ of the last ridge 31 of the outer thread 4 before the tip 3 might be 50% smaller than the largest outer diameter D′ of the thread 4.

In addition, a distance between the tip 3 and the particular ridge 32 of the outer thread 4 that is arranged closest to the tip 3 and has an outer diameter D that corresponds to the largest outer diameter D′ of the thread 4, the so called thread runout, might be around 3 mm.

The core diameter d remains the same along the total length of the outer thread 4.

A thread-free section 21 of the shank 2 extends between the fastening head 1 and the outer thread 4 in a direction of the main axis 10.

In particular, the thread-free section 21 might have a length of around 6 mm. In particular, a diameter of the thread-free section 21 might correspond more or less to the largest outer diameter D′ of the outer thread 4. In another embodiment, a diameter of the thread-free section 21 can also be smaller than the largest outer diameter D′ of the outer thread 4.

In particular, a diameter of the thread-free section 21 of the shank 2 is smaller than the diameter of the fastening head 1.

The fastening element might be rotated in both directions around the main axis. For the embodiment of the screw shown in FIG. 1 having a right-handed thread, the element is screwed into a material by a rotation in a clockwise direction, wherein a rotation in a counterclockwise direction enables the loosening of the screw out of the material.

FIG. 2 shows a side view of the fastening element 100 from FIG. 1. The fastening head 1 is shown, wherein the main axis 10 is directed into the drawing plane.

The fastening head is configured to receive a torque or a turning load respectively, such that the fastening element can be rotated around the main axis. Therefore, the fastening head has a reception for a tool that can apply a torque. In particular, the reception is formed as a hexalobular socket 11 as shown in FIG. 2.

FIG. 3 shows a cross section of the outer thread 4 of detail A of FIG. 1. The thread profile of the second thread flank 42 has a kink 43 that separates the second thread flank 42 in a first section 421 between thread base 33 and kink 43 and a second section 422 between kink 43 and thread tip 45. A first angle a1 between the first thread flank 41 and the first section 421 of the second thread flank 42 is larger than a second angle a2 between the first thread flank 41 and the second section 422 of the second thread flank 42. The first angle a1 is preferably around 40%, 50%, or 60% larger than the second angle a2. In particular, the first angle a1 is around 60° and the second angle a2 is around 30°.

The cross section of the outer thread 4 shown in FIG. 3 is preferably formed along the whole extension of the usable thread length of the outer thread. In the thread runouts of the outer thread 4, close to the tip 3 and close to the fastening head 1, the cross section of the thread profile might distinguish from the one in FIG. 3.

While the present application describes preferred embodiments of the invention, it is clearly mentioned, that the invention is not limited to those and can also be enabled in a different manner falling within the scope of the following claims.

1.-17. (canceled)

18. Fastening element for a porous material, in particular for balsa wood, comprising
a fastening head configured to receive
a torque in both rotational directions around a main axis,
a shank extending from the fastening head and ending in a tip at the end facing away from the fastening head,
wherein the shank has an outer thread along at least a section of its extension in a direction of the main axis, for screwing the fastening element into the material,
wherein the ratio of the outer diameter (D) of the outer thread along at least a section of its extension in a direction of the main axis and the core diameter (d) of the outer thread is D/d>2.5,
wherein the outer thread has a first thread flank facing the fastening head and a second thread flank facing away from the fastening head,
wherein the outer thread extends until the tip and wherein in particular the outer diameter (D) of the outer thread decreases towards the tip,
wherein the thread profile of the second thread flank has a kink such that a first angle (a1) between the first thread flank and a first section of the second thread flank is larger between the kink and a thread base than a second angle (a2) between the first thread flank and a second section of the second thread flank between the kink and a thread tip.

19. Fastening element according to claim 18, wherein the outer thread is a self-tapping thread, for forming the material when screwing the fastening element into the material.

20. Fastening element according to claim 18, wherein the core diameter (d) of the outer thread remains the same along the total length of the outer thread.

21. Fastening element according to claim 18,
wherein an angle between the first thread flank and the thread base is constant along the whole thread profile of the first thread flank.

22. Fastening element according to claim 18,
wherein the first angle (a1) is between 45° and 65°, in particular between 55° and 60° and/or
wherein the second angle (a2) is between 20° and 40°, in particular between 30° and 35°.

23. Fastening element according to claim 18, with D/d>2.8.

24. Fastening element according to claim 18,
wherein the outer diameter (D) of the outer thread is between 4 mm and 5 mm and/or
wherein the core diameter (d) of the outer thread is between 1 mm and 2 mm.

25. Fastening element according to claim 18, wherein the thread pitch is between 1.5 mm and 2 mm.

26. Fastening element according to claim 18, wherein a length of the shank from an end facing the fastening head to the tip is between 10 mm and 25 mm.

27. Fastening element according to claim 18, comprising steel, aluminium, fiber-reinforced plastic, or a combination thereof.

28. Fastening element according to claim 18, wherein the reception of the torque of the fastening head is formed as a hexalobular socket.

29. Fastening element according to claim 18, wherein a diameter of the fastening head is larger than the outer diameter (D) of the outer thread.

30. Fastening element according to claim 18, wherein the ratio of the outer diameter D and the thread pitch s is 2<D/s<3, in particular is D/s=2.5.

31. Use of the fastening element according to claim 18 for screwing into the porous material.

32. Use according to claim 31 wherein the porous material is balsa wood, foamed plastic, or aluminium foam.

33. Use according to claim 31, wherein the porous material has a density p of ρ<1 g/cm³.
